(19) United States
(12) Patent Application Publication
(10) Pub. No.: US 2002/0194829 A1
(43) Pub. Date: Dec. 26, 2002

(54) CENTRIFUGAL LOCK FOR ARTICULATED ROTATING WORKING ELEMENT

(75) Inventors: John Gregory Petersen, Ottumwa, IA (US); Michael Joseph Verhulst, Ottumwa, IA (US); Charles Scott Sloan, Blakesburg, IA (US)

Correspondence Address: Jimmie R. Oaks, Patent Department, DEERE & COMPANY, One John Deere Place, Moline, IL, 61265-8098, US

(73) Assignee: Deere & Company, a Delaware corporation

(21) Appl. No.: 09/885,461

(22) Filed: Jun. 20, 2001

(51) Int. Cl. A01D 34/52

(52) U.S. Cl. 56/255

(57) ABSTRACT

A rotary disc cutter and a rotary impeller are disclosed as examples of devices which utilize a coupling arrangement forming a detent, for the cutter knives of the disc cutter and the impeller tines of the rotary impeller, which acts, in response to centrifugal force during operation, to retain the knives and tines in radially extended positions. In the rotary disc cutter and one variant of the rotary impeller, respective holes in ends of the knives and tines are shaped to cooperate with a square section of respective fasteners so as to accomplish the detent action, while in a second variant of the rotary impeller, the detent action is due to the cooperation between respective fasteners and complementary shaped tine mount sections.

### FIELD OF THE INVENTION

The present invention relates to mountings for articulated rotating elements such as flail mounted mower blades, crop conditioner impeller tines, rotary cutter disc blades, hammer mill hammers and the like.

### BACKGROUND OF THE INVENTION

Centrifugal force acting on working elements such as tines, blades, hammers and the like, which are pivotally mounted to a rotor or other rotating member, tend to cause the working elements to pivot to radially outward positions from the axis of rotation of the rotor or other rotating member.

In known designs, in cases where the elements are knives cutting a crop, adverse crop conditions can cause the knives to fold back, reducing cut quality. For example, some stems are left uncut while others are cut such that they leave a ragged appearance. In cases of known designs where tines are being used to transport crop, the tines fold back when encountering heavy crop resulting in a loss of transport effectiveness.

### SUMMARY OF THE INVENTION

According to the present invention there is provided an improved mounting arrangement for working elements that are pivotally mounted to a rotor or other rotating body or member.

An object of the invention is to provide a mounting arrangement for connecting working elements to a rotor or other rotating member that results in the working elements staying extended against higher resistance than occurs from using the mountings of the prior art.

A more specific object of the invention is to provide a mounting arrangement, as set forth in the previous object, wherein the arrangement defines a knife mounting hole and mounting bolt or pin shaped so as to define a detent which is operative in response to centrifugal force acting on the knife during rotation of the rotor carrying the knife to resist the tendency of the knife to fold back.

These and other objects of the invention will become apparent from a reading of the ensuing description together with the appended drawings.

### BRIEF DESCRIPTION OF THE DRAWINGS

FIG. 1 is a top plan view of a rotary cutter disc having its knives mounted in accordance with the present invention.

FIG. 2 is a perspective, exploded view showing one of the knife mounting bolts and the knives of the cutter disc shown in FIG. 1.

FIG. 3 is a top plan view of the knife mounting bolt and knife shown in FIG. 2.

FIG. 4 is a perspective view showing a first variant of an alternative embodiment wherein the centrifugal lock is used to attach a Y-shaped tine arrangement to an impeller rotor.

FIG. 5 is an end view of the rotor and mounted blade of the impeller rotor shown in FIG. 4.

FIG. 6 is a view like FIG. 4 but showing a second variant of the alternate embodiment of the centrifugal lock.

### DESCRIPTION OF THE PREFERRED EMBODIMENT

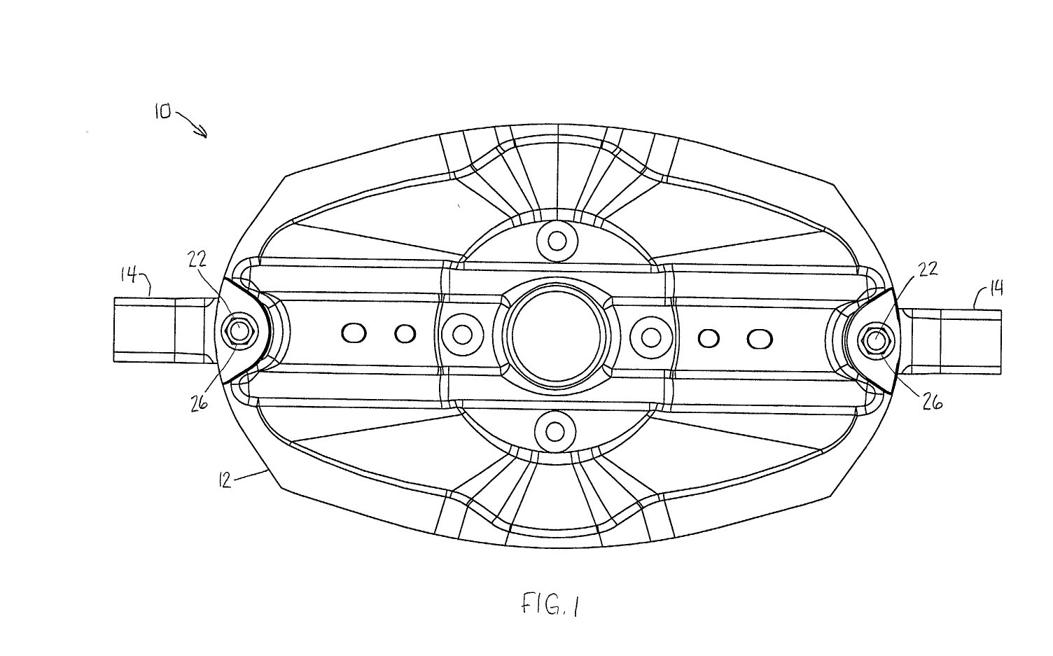

Referring now to FIG. 1, there is shown a first embodiment of the invention as applied to a rotary cutter assembly 10 including an oval-shaped cutter disc 12 having a pair of knives 14 secured thereto at respective locations at opposite extremes of the major dimension of the cutter disc 12.

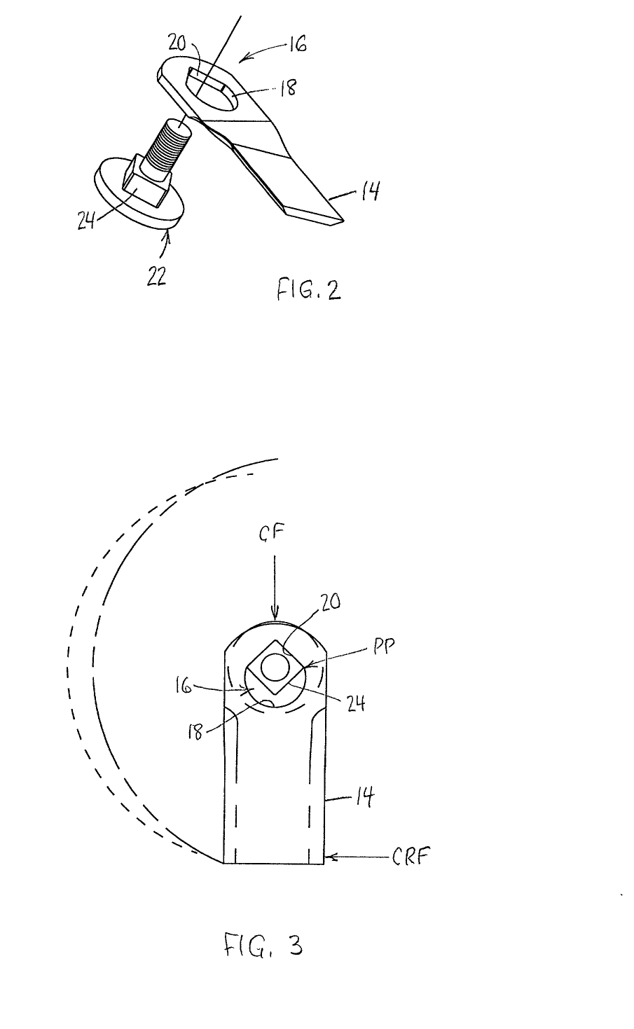

Referring now also to FIGS. 2 and 3, it can be seen that each knife 14 includes a radially inner end provided with a mounting hole 16 bounded by an arcuate, radially outer section 18, that is slightly greater than a semi-circle (approximately 210° in the disclosed embodiment) and joined to a radially inwardly converging V-shaped section 20. A knife mounting bolt 22 includes a square shoulder 24 having adjacent sides shaped complimentary to the V-shaped section 20 of the mounting hole 16. When the bolt 22 is located in place in the disc 12 for holding the associated knife 14, the shoulder 24 is located in the knife mounting hole 16, with one set of opposite corners being located on a line extending radially from the axis of rotation of the disc 12. A nut 26 is received on the threaded end of the bolt 22 so as to secure the knife 14 to the disc 12.

During operation, the disc 12 rotates about its central axis resulting in centrifugal force CF acting radially outwardly on each knife 14, as shown in FIG. 3. Adjacent sides of the square shoulder 24 of the mounting bolt 22 are then seated in the V-shaped section 20 of the mounting hole 16. Assuming a counterclockwise rotation of the disc 12, as viewed in FIG. 1, the crop being cut will exert a resisting force RF on the knife 14, as shown in FIG. 3. The leading corner of the shoulder 24 will then act as a pivot point PP about which the knife 14 will fold when an obstacle is engaged since only then will the resistance force RF be sufficient to overcome the resistance to pivoting offered by the detent formed from the adjacent sides of the shoulder 24 and the V-shaped section 20 of the mounting hole 16. Once an obstacle is encountered and the knife 14 begins to fold back, clearance in the mounting hole 16 afforded by the arcuate section 18 will allow the knife to pivot freely around.

Thus, it will be appreciated that the knives 14 stay extended against higher resistance as opposed to knives with typical round mounting holes. Advantages are that lower power is required to keep the knives extended in the operating position, with the result that the discs can be driven at a lower rpm thus making less air turbulence to blow the standing crop over. Furthermore, with the knives 14 always extended during cutting, increased cutting performance results. Also, in the event that an obstacle is struck, the knife tip radius path is moved sideways during fold back which gives more clearance to knives on neighboring discs.

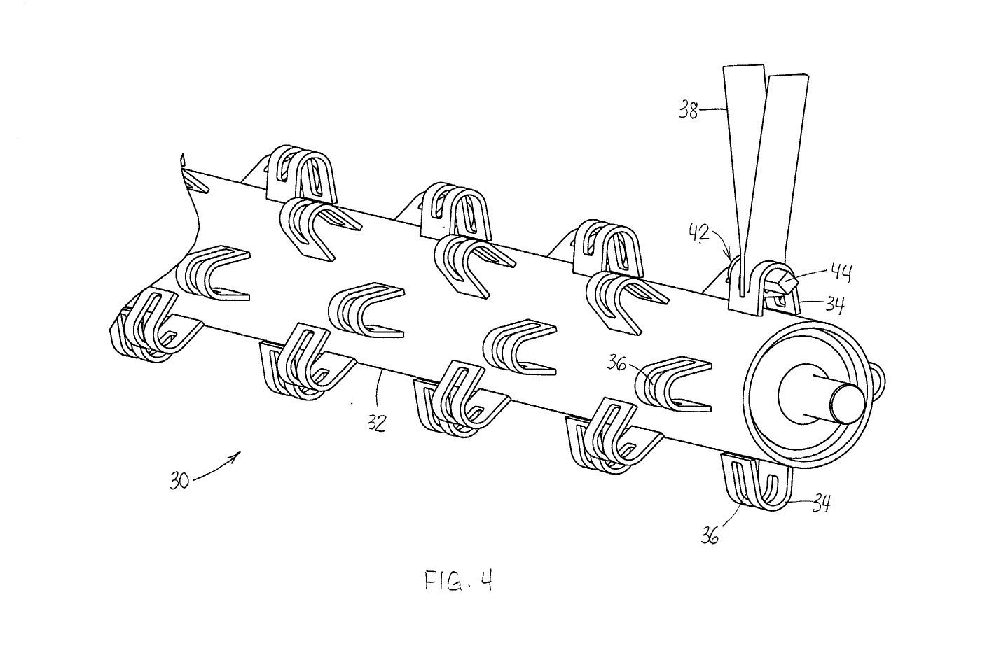

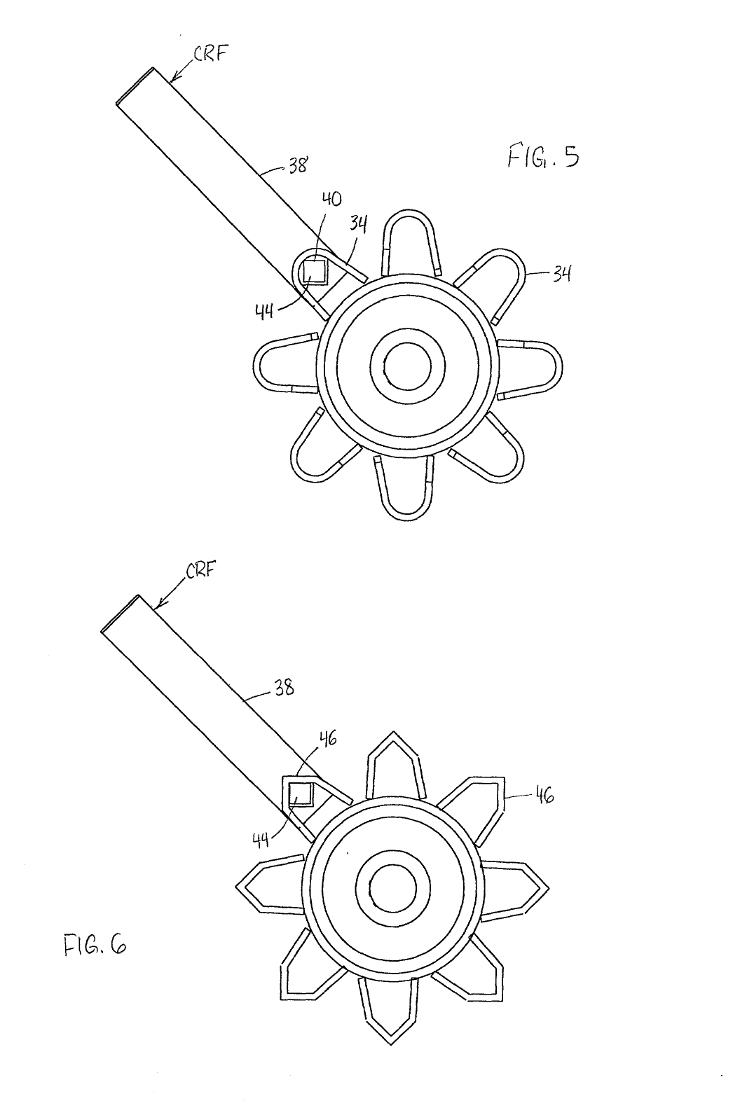

Referring now to FIGS. 4 and 5, there is shown a second embodiment of the invention in the form of a rotary impeller 30 including a cylindrical rotor 32 having the legs of a plurality of U-shaped tine mounts 34 welded thereto. The mounts 34 are each provided with a mounting slot 36 in which is received the inner end of a Y-shaped tine 38, the tine inner end being provided with a mounting hole 40 (FIG. 5) shaped like the blade mounting hole 16 of the previously described embodiment, and oriented such that a V-shaped section of the hole 40 converges radially inwardly towards the axis rotation of the rotor 32 when the tine 38 extends radially, as shown in FIG. 5. A fastener 42 includes a stem 44, which is square in cross section, received in the hole 40 and pinned, in a well known manner not shown, so as to hold the fastener in place and prevent the tine 38 from moving out of the mounting slot 36.

Referring now to FIG. 6, there is shown a variant of the second embodiment wherein, instead of the U-shaped tine mounts 34, the rotor 32 is provided with a plurality of tine mounts 46 (only one shown) having V-shaped outer sections, with the fastener 42 being received in a complimentary shaped hole of the tine 38 so that the two parts move together. The flat sides of the fastener 42 then mate with the converging sides if the V-shaped sections of the tine mounts 46 and are forced against them when the tines are radially extended to their first position by centrifugal force during rotation. The inwardly diverging legs of the tine mount 46 would provide the necessary clearance for the tine to fold back when encountering conditions which result in the force acting on the tine overcoming the resistance at the mating flats to the fold back motion of the tine.

Like in the previous embodiment, during operation of the first variant of the second embodiment (FIGS. 4 and 5), centrifugal force urges the tine 38 radially outwardly such that the V-shaped section of the hole 40 presses against the cooperating surfaces of the fastener 42 so as to offer considerable resistance to the tendency of the tine 38 to be folded back by a resistance force RF imposed on the tine 38 by the crop engaged by the tine. The advantage is that the impeller 30 will move cut crop in a more efficient manner when the tines 38 are fully extended.

In the second variant (FIG. 6), the converging sides of the fastener 42 are urged against the converging outer surfaces of the associated mount 46 by centrifugal force during operation, with the space between the legs providing the necessary clearance for permitting the tine 38 to fold back to its second position when the tine is overloaded.

It is to be understood that the two embodiments disclosed here are only representative of the various applications which may take advantage of the benefits of the invention. Any situation where it is desired that the pivotally mounted working element stay in a fully extended, radial attitude, as caused by centrifugal force, until considerable working resistance is encountered would be a candidate for the use of the invention.

Having described the preferred embodiment, it will become apparent that various modifications can be made without departing from the scope of the invention as defined in the accompanying claims.

1. In a device including a body mounted for rotating about a fixed axis, at least one working element and a fastener extending through openings in said body and said working element and cooperating therewith to define a coupling allowing said working element to move between a first position, wherein it extends radially to said fixed axis, and a second position wherein it is folded back in trailing relationship to said first position with respect to a working direction of rotation of said body, the improvement comprising: said coupling including non-circular mating surfaces respectively on said fastener and one of said body and working element which are forced together by centrifugal force during normal working conditions when said body is rotating in said working direction so as to create an interlocking force resisting movement of said working element to said second position; and said coupling including sufficient clearance for permitting said working element to move to said second position in response to said working element encountering a working force sufficient to overcome said interlocking force.

2. The device as set forth in claim 1 wherein said non-circular mating surfaces are respective pairs of flat surfaces which converge to form respective corners located on a line extending radially from said fixed axis when said working element is in said first position.

3. The device as set forth in claim 1 wherein said non-circular mating surfaces are respectively provided on said fastener and said working element.

4. The device as set forth in claim 1 wherein said non-circular mating surfaces are respectively provided on said fastener and said body.

5. The device as set forth in claim 3 wherein said working element is provided with a mounting opening at one end; said mounting opening having said non-circular mating surface at a radially outer section thereof.

6. The device as set forth in claim 5 wherein said non-circular mounting surface of said working element is defined by a pair of radially outwardly converging flat surfaces; and said mounting opening including a circular radially inward section having opposite ends respectively joined to said pair of flat surfaces.

7. The device as set forth in claim 6 wherein said body is a rotary mower disc and said working element is a cutting knife.

8. The device as set forth in claim 3 wherein said body is a cylindrical rotor and said working element is a tine.

9. The device as set forth in claim 8 wherein said tine has an opening in one end thereof; said non-circular mating surface of said tine including a first pair of flat sides forming a first section of said opening and converging radially outwardly when said tine is in said first position; and said opening including a second section in the form of a circular surface having opposite ends respectively joined to said first pair of flat sides; and said fastener having a second pair of flat sides formed complementary to said first pair of flat sides.

10. The device as set forth in claim 4 wherein said body is a rotor including at least one tine mount including a pair of legs having radially outward converging side sections located along a radial line extending from said axis; said legs containing a slot receiving said end of said tine; said fastener extending cross ways through said end of said tine and having a section formed of converging sides shaped complementary to said converging side sections of said legs, whereby centrifugal force will act to force said converging sides of said fastener against said converging side sections of said legs of said tine mount during rotation of said rotor so as to resist movement of said tine to said second position.
